(19) United States
(12) Patent Application Publication
(10) Pub. No.: US 2026/0056508 A1
(43) Pub. Date: Feb. 26, 2026

(54) INFORMATION PROVISION SYSTEM AND INFORMATION PROVISION METHOD

(71) Applicant: CANON KABUSHIKI KAISHA, Tokyo (JP)

(72) Inventor: TAKUYA HAYATO, Kanagawa (JP)

(21) Appl. No.: 19/297,242

(22) Filed: Aug. 12, 2025

(30) Foreign Application Priority Data
Aug. 21, 2024 (JP) 2024-139975
Mar. 19, 2025 (JP) 2025-045621

(51) Int. Cl. G03G 21/18; G03G 15/00

(52) U.S. Cl. CPC G03G 21/1892; G03G 15/553

(57) ABSTRACT

There is provided an information provision system including: a database configured to store history information indicating a replacement history of replaceable parts constituting an image-forming apparatus; a generation unit configured to determine one or more parts currently constituting the image-forming apparatus from the history information and generate state information of the image-forming apparatus based on a state of the one or more parts; and an information provision unit configured to provide the state information of the image-forming apparatus generated by the generation unit to a user terminal, in response to a request from the user terminal.

### BACKGROUND

### Field of the Technology

The present disclosure relates to an information provision system and an information provision method.

### Description of the Related Art

Many image-forming apparatuses include replaceable parts such as a cartridge, a fixing device, an intermediate transfer belt, and a feeding roller, for example, so that the lifetime of the apparatus is kept long or to improve the maintainability. The replaceable parts are typically classified into genuine products manufactured at the factory of the manufacturer of the apparatus main body, recycled products obtained by remanufacturing spent genuine products, and non-genuine products manufactured at the factory of a service provider that is different from the manufacturer of the apparatus main body. The performance and output quality of used image-forming apparatuses may change depending on which type of part is installed in the apparatus and used. Japanese Patent Laid-Open No. 2005-070254 discloses a technology in which, to enable the image-forming apparatus to operate in optimal operation conditions regardless of the cartridge used, the image-forming apparatus reads out information written in a memory of the cartridge and uses the read information to control an image-forming operation.

An image-forming apparatus may be sold as a used product after parts are replaced, and may be reused. The value of a used image-forming apparatus depends on which types of parts constitute the apparatus. For example, an apparatus that includes an installed part with a short remaining lifetime is highly likely to be defective due to the remaining lifetime of the part running out before much time passes after the purchase by the user. Japanese Patent Laid-Open No. 2004-070444 discloses a technology for converting the value of a used image-forming apparatus into a numerical value as a purchase price on the basis of wear levels of the parts, and providing value information to a terminal of a service provider that collects the apparatus. With the technology of Japanese Patent Laid-Open No. 2004-070444, wear levels for the types of parts, such as a photosensitive drum, a halogen lamp, and a power source unit, are managed in a database, and a wear level is reset to zero when a part is replaced.

However, with the technology of Japanese Patent Laid-Open No. 2004-070444, by merely resetting a wear level to zero when a part is replaced, differences in the lifetime and performance specific to the part is not taken into account, and also the value information is merely provided to collection service providers.

### SUMMARY

The present disclosure enables realization of a mechanism for providing a user with information allowing them to determine an appropriate value for an image-forming apparatus with parts that can be replaced with not only genuine products but also recycled products and non-genuine products.

According to one aspect, there is provided an information provision system including: a database configured to store history information indicating a replacement history of replaceable parts constituting an image-forming apparatus; a generation unit configured to determine one or more parts currently constituting the image-forming apparatus from the history information and generate state information of the image-forming apparatus based on a state of the one or more parts; and an information provision unit configured to provide the state information of the image-forming apparatus generated by the generation unit to a user terminal, in response to a request from the user terminal. A corresponding information provision method is also provided.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a configuration of an image-forming apparatus to which the technology according to the present disclosure may be applied.

FIG. 2 is a schematic view for a schematic configuration of an information provision system according to an embodiment.

FIG. 3 is a block diagram illustrating an example of a configuration of a worker terminal according to an embodiment.

FIG. 4 is an explanatory diagram illustrating an example of a configuration code information according to an embodiment.

FIG. 5 is an explanatory diagram illustrating an example of a configuration of a history record according to an embodiment.

FIG. 6 is a block diagram illustrating an example of a configuration of a history server according to an embodiment.

FIG. 7 is an explanatory diagram illustrating an example of a configuration of a rank information record according to an embodiment.

FIG. 8 is a block diagram illustrating an example of a configuration of a state determination server according to an embodiment.

FIG. 9 is an explanatory diagram illustrating an example of a configuration of an apparatus table according to an embodiment.

FIG. 10 is an explanatory diagram illustrating an example of a configuration of a part table according to an embodiment.

FIG. 11 is a block diagram illustrating an example of a configuration of a user terminal according to an embodiment.

FIG. 12 is an explanatory diagram for describing an example of the life cycle of an image-forming apparatus.

FIG. 13 is a sequence diagram illustrating an example of a flow of state information generation processing according to an embodiment.

FIG. 14 is a sequence diagram illustrating an example of a flow of information provision processing according to an embodiment.

FIG. 15A is an explanatory diagram illustrating a first example of a configuration of a screen displaying state information.

FIG. 15B is an explanatory diagram illustrating a second example of a configuration of a screen displaying state information.

FIG. 15C is an explanatory diagram illustrating a third example of a configuration of a screen displaying state information.

FIG. 16 is a block diagram illustrating an example of a configuration of a history server according to a first modification example.

FIG. 17 is a block diagram illustrating an example of a configuration of a state determination server according to a first modification example.

FIG. 18 is a sequence diagram illustrating an example of a flow of information provision processing according to the first modification example.

FIG. 19 is a block diagram illustrating an example of a configuration of an image-forming apparatus according to a second modification embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. SYSTEM OVERVIEW

### 1-1. Printer Configuration Example

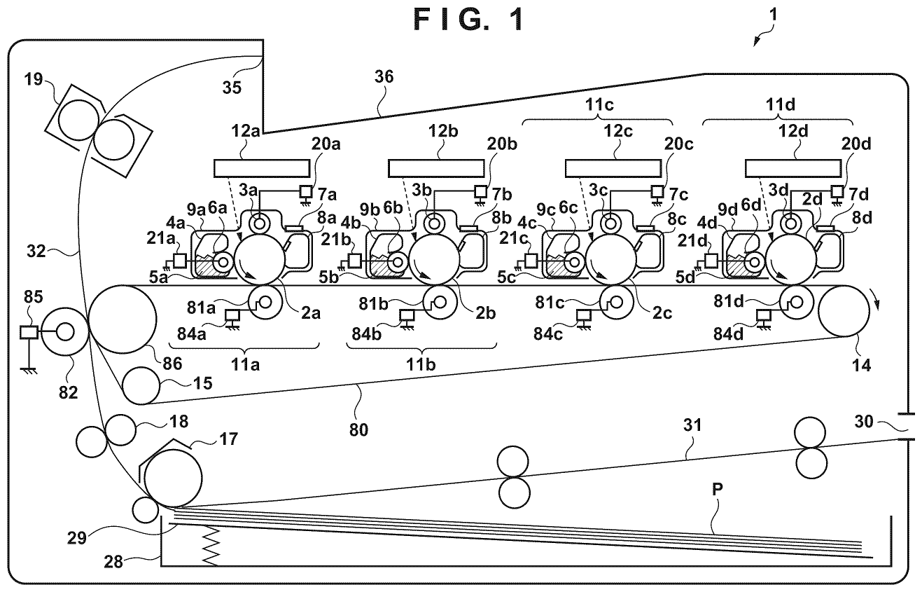

FIG. 1 is a schematic view of a configuration of a printer 1, which is an example of an image-forming apparatus to which the technology according to the present disclosure may be applied. In the present embodiment, an example in which the printer 1 is a color laser printer that can form a color image on a sheet via electro-photography will be mainly described. In other embodiments, the printer 1 may be a monochrome laser printer, an inkjet printer, or another type of printer. Note that the technology according to the present disclosure can be applied to another type of image-forming apparatus such as a copying machine or a multi-function peripheral.

As illustrated in FIG. 1, the printer 1 includes a first station 11a, a second station 11b, a third station 11c, and a fourth station 11d. For example, the first station 11a is an image-forming unit that forms a yellow (Y) toner image. The second station 11b is an image-forming unit that forms a magenta (M) toner image. The third station 11c is an image-forming unit that forms a cyan (C) toner image. The fourth station 11d is an image-forming unit that forms a black (K) toner image. The configuration of the four stations may be similar. Thus, the configuration of the first station 11a will be described below as an example.

In the first station 11a, a photosensitive drum 2a is a cylindrical image carrier including a plurality of layers such as a carrier generation layer and a charge transport layer. The photosensitive drum 2a rotates in the anticlockwise direction in the diagram. A charging roller 3a is in contact with the photosensitive drum 2a and rotates being driven by the rotation of the photosensitive drum 2a. The charging roller 3a is applied with a charging voltage from a charging bias power source 20a, and uniformly charges the surface of the photosensitive drum 2a. An exposure device 12a forms an electrostatic latent image on the surface of the photosensitive drum 2a by exposing the surface of the photosensitive drum 2a to a laser beam modulated according to an input image signal. The laser beam from the exposure device 12a scans the surface of the photosensitive drum 2a via a polygon mirror in the main scan direction (the depth direction in the diagram). A developing device 4a includes a toner containing portion 5a and a developing roller 6a. The toner containing portion 5a contains the toner (yellow in this example), which is a non-magnetic single-component development agent, for example. The developing roller 6a is applied with a development voltage from a developing bias power source 21a and supplies the toner contained in the toner containing portion 5a to the surface of the photosensitive drum 2a to develop the electrostatic latent image and form a toner image. A cleaner 8a removes the toner remaining on the surface of the photosensitive drum 2a after the transfer of the toner image described below.

The photosensitive drum 2a, the charging roller 3a, the developing device 4a, and the cleaner 8a described above are housed in a cartridge 9a. The cartridge 9a can be attached to and detached from the main body of the printer 1. The cartridge 9a further includes a storage device 7a. The storage device 7a pre-stores information related to characteristics of component elements (for example, the members and toner described above) inside the cartridge 9a.

The description of the first station 11a also applies to the second station 11b, the third station 11c, and the fourth station 11d, with the character “a” at the end of the reference sign being replaced with “b”, “c” and “d”, respectively.

An intermediate transfer belt 80 is mounted at tension on a driving roller 14, a tension roller 15, and a secondary transfer facing roller 86 and circulates in the clockwise direction of the diagram being driven by the rotation of the driving roller 14. Primary transfer rollers 81a, 81b, 81c, and 81d are disposed on the opposite side of the intermediate transfer belt 80 from the photosensitive drums 2a, 2b, 2c, and 2d, respectively. The primary transfer rollers 81a, 81b, 81c, and 81d are applied with a primary transfer voltage from primary transfer bias power sources 84a, 84b, 84c, and 84d and transfer the toner images formed on the surfaces of the photosensitive drums 2a, 2b, 2c, and 2d in order on top of one another on the intermediate transfer belt 80. As a result, a full color toner image is formed on the intermediate transfer belt 80.

A cassette 28 houses a stack of sheets. A bottom plate 29 of the bottom surface of the cassette 28 is fixed at one end (right end in the diagram) to the cassette 28. The other end (left end in the diagram) of the bottom plate 29 rises up in synchronization with the driving of a feeding roller 17 to push up the stack of sheets loaded on the bottom plate 29. The feeding roller 17 comes into contact with one sheet P at the top of the stack of sheets, separates the sheet P from the remaining sheets, and feeds the sheet P to a conveying path 32. In a case where the sheet is supplied to a manual feed tray 31 from a feed opening 30, the feeding roller 17 can feed the sheet to the conveying path 32. A registration roller 18 sends the sheet fed by the feeding roller 17 to a secondary transfer position between a secondary transfer roller 82 and the intermediate transfer belt 80.

The secondary transfer roller 82 is applied with a secondary transfer voltage from a secondary transfer bias power source 85. The secondary transfer roller 82 transfers the full color toner image conveyed to the secondary transfer position by the intermediate transfer belt 80 to the sheet conveyed along the conveying path 32. After passing the secondary transfer position, the sheet arrives at a downstream fixing device 19.

The fixing device 19 is a fixing unit that applies heat and pressure to the toner image on the sheet to fix the toner image to the sheet while holding and conveying the sheet by flexible pressing rollers. The toner of the toner image is melted by the heat from the fixing belt heated to the fixing temperature and is fixed to the sheet. After passing the fixing device 19, the sheet is discharged from a discharge opening 35 to a discharge tray 36.

### 1-2. Part Replacement

In the printer 1, the cartridges 9a, 9b, 9c, and 9d, the feeding roller 17, the fixing device 19, and the intermediate transfer belt 80 are parts that wear as the image-forming operation is repeated. These parts are designed to be replaceable parts. Each part has a specific lifetime and performance, and a part that has exhausted its remaining lifetime is replaced with a new part. If the new part is a genuine product like the original part, the lifetime and performance of the part is the same as before replacement, allowing for slight individual differences. However, in a case where the new part is a recycled product or a non-genuine product, the lifetime and performance of the new product is different from before replacement, and this difference may affect the overall state of the apparatus. In a case where the new part is a genuine product of a model different from the original part, the lifetime or performance of the part may be different from before replacement.

As an example, among fixing devices that can be installed in the same printer, fixing devices of different fixing performance exist. A fixing device with high fixing performance can fix an image to a wider variety of sheets compared to a fixing device with low fixing performance. When a fixing device with low fixing performance is used, depending on the type of sheet, the image may not be sufficiently fixed, resulting in poor image quality. The performance of a genuine product fixing device can be used as a reference set to 100%, and the performance of other fixing devices can be represented as a percentage. The performance of a fixing device that can fix images to a wider variety of sheets than the reference is represented by a value greater than 100% (for example, 105%). The performance of a fixing device that can only fix images to a smaller variety of sheets than the reference is represented by a value less than 100% (for example, 70%).

As another example, among the feeding rollers that can be installed in the same printer, feeding rollers of different feeding performance exist. A feeding roller with high feeding performance has a lower probability of jamming occurring than a feeding roller with low feeding performance. The performance of a genuine product feeding roller can be used as a reference set to 100%, and the performance of other feeding rollers can be represented as a percentage. The performance of a feeding roller with a lower probability of jamming occurring than the reference is represented by a value greater than 100% (for example, 110%). The performance of a feeding roller with a higher probability of jamming occurring than the reference is represented by a value less than 100% (for example, 90%).

As yet another example, among the intermediate transfer belt that can be installed in the same printer, intermediate transfer belts of different transfer performance exist. An intermediate transfer belt with low transfer performance has a higher probability of a transfer defect (for example, reduced density or the like) than an intermediate transfer belt with high transfer performance. The performance of a genuine product intermediate transfer belt can be used as a reference set to 100%, and the performance of other intermediate transfer belts can be represented as a percentage. The performance of an intermediate transfer belt with a lower probability of a transfer defect occurring than the reference is represented by a value greater than 100% (for example, 120%). The performance of an intermediate transfer belt with a higher probability of a transfer defect occurring than the reference is represented by a value less than 100% (for example, 80%).

The value of a replaceable part depends also on the remaining lifetime of each part. Each part has a specific lifetime, and the remaining lifetime decreases as the part is repeatedly used. When a part with zero remaining lifetime is used, the image-forming operation is not performed as expected, and there is a high probability of a malfunction or a certain defect occurring. A lifetime of a part in its initial state is referred to as a nominal lifetime, and this may be represented, for example, by the number of sheets printable. For example, the lifetime of a fixing device with which printing can be performed on 250000 sheets is longer than the lifetime of a fixing device with which printing can be performed on 200000 sheets. The remaining lifetime of a fixing device of which nominal lifetime is 250000 sheets and has been used to print 200000 sheets is 50000. Not only the parts but also a main body of a printer has a nominal lifetime and a remaining lifetime. In many cases, the nominal lifetime of a main body of a printer is sufficiently longer than the nominal lifetime of its parts.

A numerical values of the performance and lifetime of a genuine product, a recycled product, and a non-genuine product may be measured through testing by the manufacturer that manufactured the printer main body or a trusted third party. Then, the data based on the measurement results is registered in advance in a database described below.

Note that the parts mentioned in the present section are merely examples of replaceable parts. A replaceable part in one embodiment may not be replaceable in another embodiment and vice versa. Also, two or more types of performance measures may be defined for one type of part (for example, for the fixing device, conveying performance may be defined in addition to fixing performance).

As described above, if a part in an image-forming apparatus is replaced with another part with a different remaining lifetime or performance, as the configuration of the image-forming apparatus will change from before replacement to after replacement, the value of the image-forming apparatus for a user will also change. In particular, in a case where a user intends to purchase or acquire a used image-forming apparatus, it is desirable to provide the user with information in which the state of the image-forming apparatus is reflected more accurately. An information provision system 10 described in detail below is a system to provide a user with information that enables him or her to determine an appropriate value of such an image-forming apparatus.

### 1-3. Life Cycle of Image Forming Apparatus

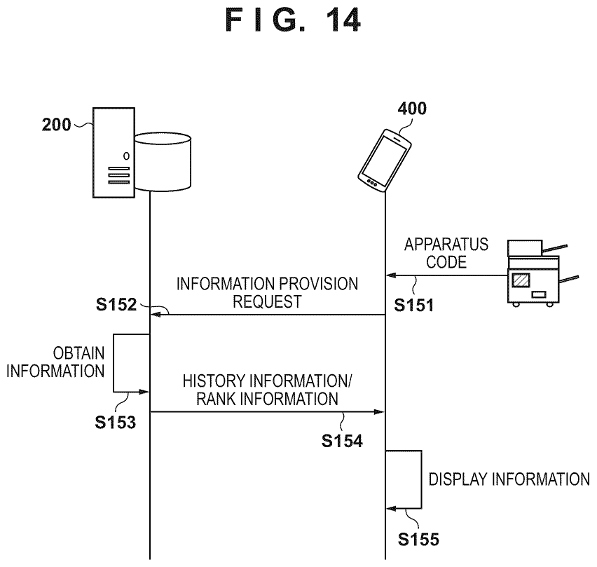

FIG. 12 is an explanatory diagram for describing an example of a life cycle of the printer 1. Processes P1 to P9 illustrated in FIG. 12 are examples of work or states experienced by the image-forming apparatus in the time from when it is manufactured as a new product to when it is discarded.

In process P1, the image-forming apparatus is manufactured as a new product by the manufacturer. In process P2, the image-forming apparatus is sold to the user. In process P3, the user who purchased the image-forming apparatus uses the image-forming apparatus. In process P4, the user or a service agent performs maintenance work such as inspection and repair of the image-forming apparatus. The service agent replaces a part of the image-forming apparatus as necessary.

The user can sell the image-forming apparatus to a service provider that deals in used products. In process P5, the service provider that deals in used products who purchased the image-forming apparatus performs overhaul work for selling the image-forming apparatus as a used product. As necessary, the service provider that deals in used products replaces a part of the image-forming apparatus. In process P6, the image-forming apparatus overhauled as a used product is sold to a user.

A user may discard an image-forming apparatus that is no longer needed. A discarded image-forming apparatus may be collected for recycling by a collection service provider or discarded. In process P7, the collection service provider collects the image-forming apparatus and performs overhaul work for selling the image-forming apparatus as a recycled product. The collection service provider replaces a part with no or little remaining lifetime with another part. The collection service provider may replace a part with another part with different performance. In process P8, the image-forming apparatus overhauled as a recycled product is sold to a user. In process P9, the image-forming apparatus is discarded.

In the information provision system 10 described in the next section, history information indicating the history of part replacement in the life cycle of the image-forming apparatus described above is stored in a database of a history server 200. The worker that performs the work to replace at least one part of the image-forming apparatus transmits a record (hereinafter referred to as a history record) of the history information identifying one or more parts constituting the image-forming apparatus after the work from a terminal apparatus for the worker or the image-forming apparatus to the history server 200. In the example of FIG. 12, in process P1, a history record 130a indicating the configuration of the apparatus manufactured as a new product is transmitted to the history server 200. Thereafter, in process P4, a history record 130b indicating the configuration of the apparatus after the maintenance work is transmitted to the history server 200. Also, in process P5, a history record 130c indicating the configuration of the apparatus as a used product is transmitted to the history server 200. Also, in process P7, a history record 130d indicating the configuration of the apparatus as a recycled product is transmitted to the history server 200. Lastly, in process P9, a history record 130e indicating the configuration of the discarded apparatus is transmitted to the history server 200. The information provision system 10 generates state information from the history information collected in this manner and provides the state information in response to a request from a user in a timely manner.

### 1-4. System Configuration

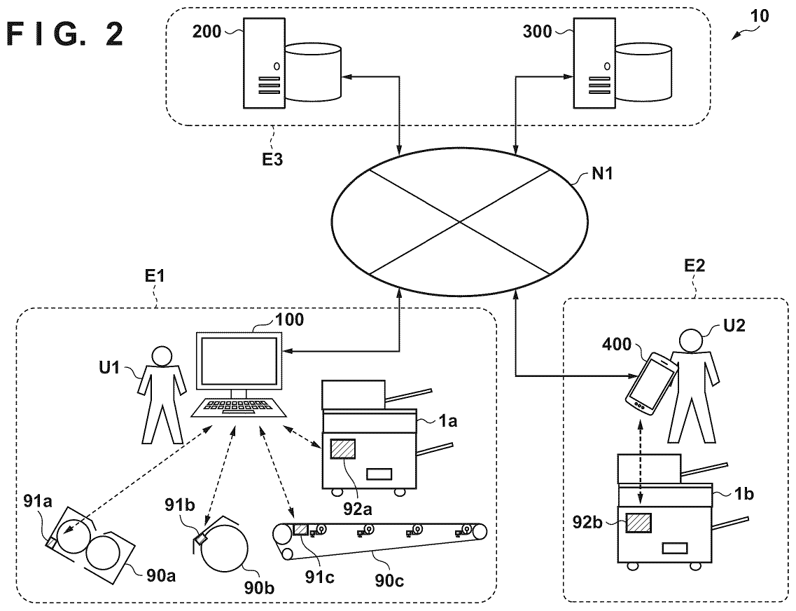

FIG. 2 is a schematic view for a schematic configuration of the information provision system 10 according to an embodiment. As illustrated in FIG. 2, the information provision system 10 includes a worker terminal 100, the history server 200, a state determination server 300, and a user terminal 400.

The worker terminal 100 is a terminal apparatus used by a worker U1 that performs work including the maintenance and overhauling of an image-forming apparatus. The worker terminal 100 may be installed in a work environment E1 where work is performed or may be carried by the worker U1. The worker terminal 100 may be a general-purpose terminal apparatus such as a personal computer (PC) or smartphone or may be a dedicated terminal apparatus for work, for example. The worker terminal 100 can communicate with other apparatuses via a network N1.

The network N1 may be the Internet, a cloud network, a private network, or any combination thereof. The network N1, for example, may include any number and type of network apparatuses such as a router, a switch, a gateway, a wireless access point, and a base station.

The history server 200 is a server apparatus that, for each image-forming apparatus under the management of the system, manages the history information indicating the replacement history of the replaceable parts constituting the image-forming apparatus. The state determination server 300 is a server apparatus that determines the state of each image-forming apparatus under the management of the system from the history information stored in the database of the history server 200 and generates state information for each image-forming apparatus. Each of the history server 200 and the state determination server 300, for example, may be implemented as an application server, a database server, or a cloud server and deployed in a remote environment E3. Each server can communicate with other apparatuses via the network N1.

The user terminal 400 is a terminal apparatus carried by a user U2 in a user environment E2. The user terminal 400 may be a general-purpose terminal apparatus such as a PC or a smartphone, for example. The user terminal 400 can communicate with other apparatuses via the network N1.

In the present embodiment, each of parts 90 that may constitute the printer 1 has a part identifier for identifying the part. The part identifier is attached or printed on each part in the form of a code that can be visually or optically read. The printer 1 also includes an apparatus identifier for identifying the main body. The apparatus identifier is attached or printed on each apparatus in the form of a code that can be visually or optically read. The worker U1 reads the apparatus identifier of the target apparatus and the part identifiers of one or more parts constituting the apparatus at a time of performing the work, and transmits the history record including a set of the read identifiers from the worker terminal 100 to the history server 200. Note that in a modification example described below, the history record is transmitted to the history server 200 by the printer 1 instead of the worker terminal 100.

In the example of FIG. 2, a printer 1a and parts 90a, 90b, and 90c exist in the work environment E1. Part codes 91a, 91b, and 91c are attached to the parts 90a, 90b, and 90c, respectively. An apparatus code 92a is attached to the printer 1a. The worker U1 replaces the fixing device of the printer 1a with the part 90a, the feeding roller with the part 90b, and the intermediate transfer belt with the part 90c. At this time, the history record transmitted from the worker terminal 100 to the history server 200 includes the apparatus identifier read from the apparatus code 92a and the part identifiers read from the part codes 91a, 91b, and 91c.

A printer 1b exists in the user environment E2. An apparatus code 92b is attached to the printer 1b. The user U2 transmits the apparatus identifier of the printer 1b read from the apparatus code 92b from the user terminal 400 to the remote environment E3, thereby he or she can request provision of the state information of the printer 1b to be requested. What kind of state information is generated on the basis of the history record transmitted to the history server 200 will be described in detail below.

In the present specification, the parts 90a, 90b, and 90c and other replaceable parts are collectively referred to as the parts 90. This also applies to the part codes 91 (91a, 91b, 91c, . . . ) and the apparatus codes 92 (92a, 92b, . . . ).

Note that the work environment E1 and the user environment E2 may be the same environment. The remote environment E3 may be separated into a plurality of different environments. Also, the functions of the history server 200 and the state determination server 300 described below may be provided by a single apparatus or may be provided by a plurality of physically distinct apparatuses cooperating with each other. A part or all of the database described as being held by a server may be held by an apparatus separate from this server (for example, another database server).

### 2. CONFIGURATION OF EACH APPARATUS

### 2-1. Worker Terminal

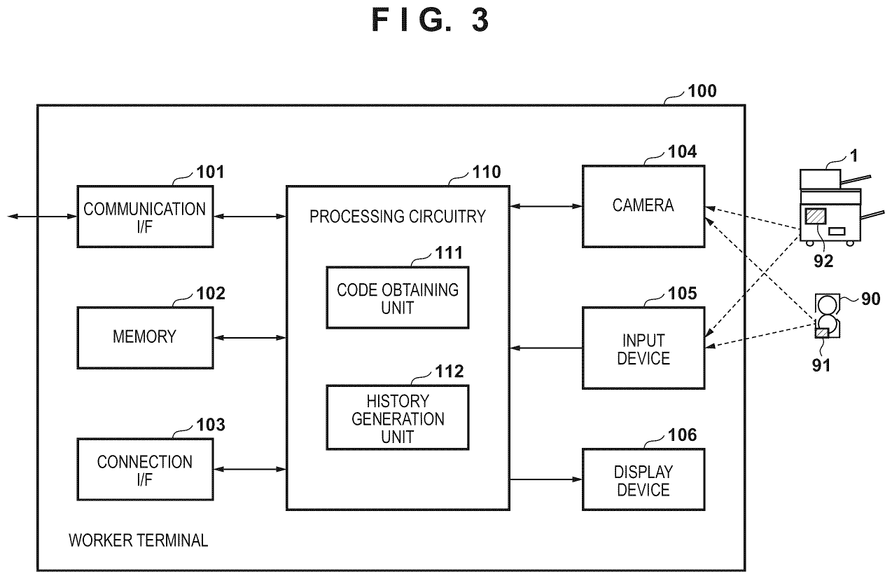

FIG. 3 is a block diagram illustrating an example of a configuration of the worker terminal 100 according to an embodiment. As illustrated in FIG. 3, the worker terminal 100 includes a communication interface (I/F) 101, a memory 102, a connection I/F 103, a camera 104, an input device 105, a display device 106, and processing circuitry 110.

The communication I/F 101 is an interface for the worker terminal 100 to communicate with other apparatuses. The communication I/F 101 may be a wired communication interface or may be a wireless communication interface.

The memory 102 may include any kind of storage medium such as a semiconductor memory (a read only memory (ROM), a random access memory (RAM), or the like), an optical disk, or a magnetic disk, for example. The memory 102 may include a non-transitory computer-readable storage medium. The memory 102 stores one or more computer programs executed by the processing circuitry 110 and various types of data.

The connection I/F 103 is the interface for the worker terminal 100 to connect to the printer 1. The connection between the worker terminal 100 and the printer 1 may be a wired connection or a wireless connection. This connection may be performed using a communication protocol for connection to peripheral devices such as Bluetooth (registered trademark) or universal serial bus (USB), for example.

The camera 104 is a module that is capable of capturing images or video of a subject. In the present embodiment, the camera 104 may be used for optically reading, from each of the apparatus codes 92 of the printers 1 and the part codes 91 of the one or more parts 90, information encoded in the code. For example, the apparatus codes 92 and the part codes 91 may be a one-dimensional barcode or a two-dimensional QR code (registered trademark).

The input device 105 is a device for accepting operations and information input by the worker U1. The input device 105, for example, may include one or more of a touch sensor, a key pad, a keyboard, a pointing device, and a microphone. For example, the apparatus codes 92 and the part codes 91 may be expressed as characters that can be read by humans. In this case, the code or information visually read by the worker U1 may be input to the worker terminal 100 via the input device 105.

The display device 106 is a display for outputting images or information. The display device 106, together with the input device 105, provides a user interface related to the work such as maintenance or overhauling of the printer 1 performed by the worker U1.

The processing circuitry 110 may be a central processing unit (CPU), for example, and provides the functions of the worker terminal 100 by executing a computer program stored in the memory 102. More specifically, in the present embodiment, the processing circuitry 110 functions as a code obtaining unit 111 and a history generation unit 112.

The code obtaining unit 111 cooperates with the camera 104 and the input device 105 to obtain information read from the apparatus code 92 of the printer 1 targeted for work and the part codes 91 of the one or more parts 90 constituting the printer 1 (hereinafter referred to as code information).

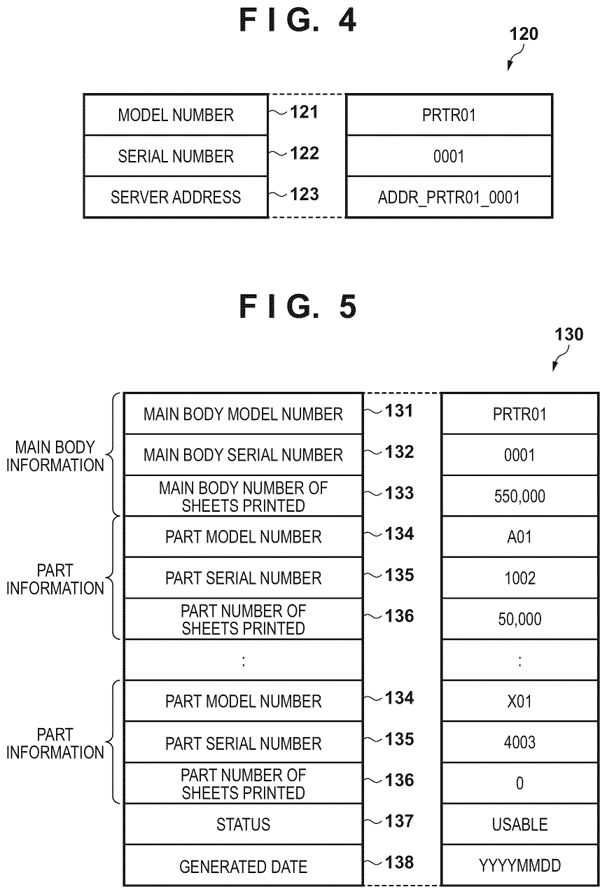

FIG. 4 is an explanatory diagram illustrating an example of a configuration of code information 120. The code information 120 includes a model number 121, a serial number 122, and a server address 123. The model number 121 is a character string for identifying the model of the apparatus or part. The serial number 122 is a number for identifying each of individual instances of the same model. In other words, each individual printer 1 and part 90 is uniquely identified by a combination of the model number 121 and the serial number 122. The combination of the model number 121 and the serial number 122 may be simply referred to as an identifier. The combination of the model number and the serial number of an image-forming apparatus corresponds to an apparatus identifier, and the combination of the model number and serial number of a part corresponds to a part identifier. The server address 123 is an address for accessing the history server 200 via the network N1. The server address 123, for example, may be the same for all of the apparatuses and products, may be different per model of the apparatuses and products, or may be different per individual instance of the apparatus and products.

The history generation unit 112 generates a history record 130 for the one or more parts 90 constituting the printer 1 on the basis of the code information 120 obtained by the code obtaining unit 111 and transmits the generated history record 130 to the history server 200.

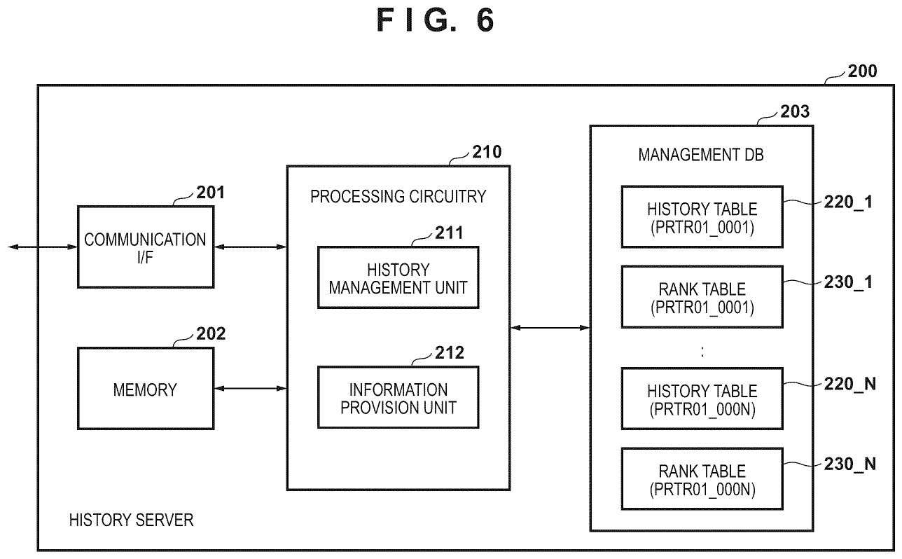

FIG. 5 is an explanatory diagram illustrating an example of a configuration of the history record 130. The history record 130 includes main body information, part information of the one or more parts, and other information.

The main body information includes a main body model number 131, a main body serial number 132, and a main body number of sheets printed 133. The main body model number 131 and the main body serial number 132 indicate the model number and the serial number obtained from the apparatus code 92 of the printer 1 targeted for work. The main body number of sheets printed 133 indicates an actual value of the number of sheets printed by the printer 1 from the start of use of the printer 1 to the time of the work. The history generation unit 112 may receive a value for the main body number of sheets printed 133 from the printer 1 via the connection I/F 103. Alternatively, the worker U1 may input a value for the number of sheets printed displayed on the control panel of the printer 1 via the input device 105, and the history generation unit 112 may obtain the input value.

The part information includes a part model number 134, a part serial number 135, and a part number of sheets printed 136. The part model number 134 and the part serial number 135 indicate the model number and the serial number read from the part code 91 of each of the parts 90 installed in the printer 1 targeted for work. The part number of sheets printed 136 indicates an actual value of the number of sheets printed by the printer 1 using the corresponding part 90. In a case where the part 90 is a new product and is installed in the printer 1, the value of the part number of sheets printed 136 may be zero. For an existing part 90, the value for the part number of sheets printed 136 indicates the number of sheets printed by the printer 1 from when the part 90 was installed in the printer 1 to the time of the work. The history generation unit 112 may receive the previous history record 130 for the printer 1 from the history server 200 and generate main body information and part information for a new history record 130 on the basis of the information indicated by the previous history record 130.

A status 137 indicates the status of the printer 1 at the point in time when the history record 130 is generated. For example, the status 137 of the history record 130 generated in process P1, P4, and P5 of the life cycle described using FIG. 12 indicates “USABLE”. The status 137 of the history record 130 generated in process P7 indicates “RECYCLED”. The status 137 of the history record 130 generated in process P9 indicates “DISCARDED”. The value for the status 137 may typically be input or selected via the input device 105 by the worker U1. A generated date 138 indicates the date on which the history record 130 was generated.

### 2-2. History Server

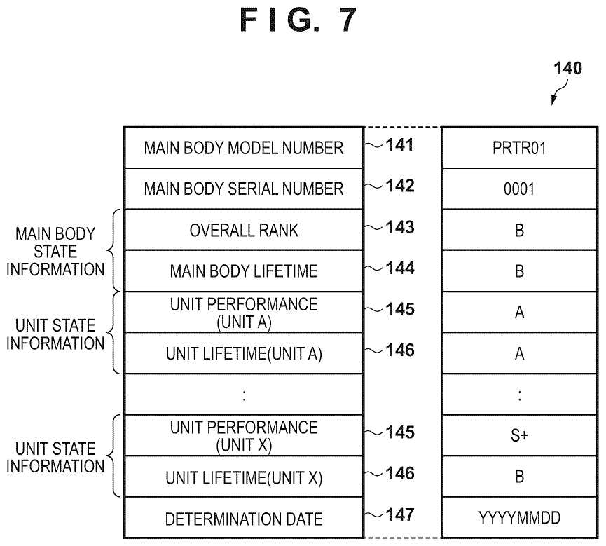

FIG. 6 is a block diagram illustrating an example of a configuration of the history server 200. As illustrated in FIG. 6, the history server 200 includes a communication I/F 201, a memory 202, a management database (DB) 203, and processing circuitry 210.

The communication I/F 201 is a communication interface for the history server 200 to communicate with other apparatuses. The communication I/F 201 may be a wired communication interface or may be a wireless communication interface.

The memory 202 may include any kind of storage medium such as a semiconductor memory, e.g. a ROM, a RAM, or the like, an optical disk, or a magnetic disk. The memory 202 may include a non-transitory computer-readable storage medium. The memory 202 stores one or more computer programs executed by the processing circuitry 210 and various types of data.

The management DB 203 is a database that stores, for each printer 1 under the management of the system, history information indicating replacement history for the parts 90 constituting the printer 1 and state information generated on the basis of the history information. The history information and the state information are stored in association with the apparatus identifier of each printer 1 on the basis of the history record 130 received from the worker terminal 100.

In the example of FIG. 6, for each of the N number of printers 1 (N being a natural number), the management DB 203 includes a history table 220_n and a rank table 230_n (n=1, . . . , N). The history table 220_n stores a set of the history records 130 having the apparatus identifier of the n-th printer 1 that have been received in the past. The data elements of the history table 220_n may be similar to the data elements of the history record 130 described using FIG. 5. Note that the N number of history tables 220_1, . . . , 220_N may be merged into one history table.

The rank table 230_n stores rank information of the printer 1 generated by the state determination server 300 on the basis of the history record 130 when each history record 130 is received from the worker terminal 100 for the n-th printer 1. The rank information is an example of state information. Note that the N number of rank tables 230_1, . . . , 230_N may be merged into one rank table.

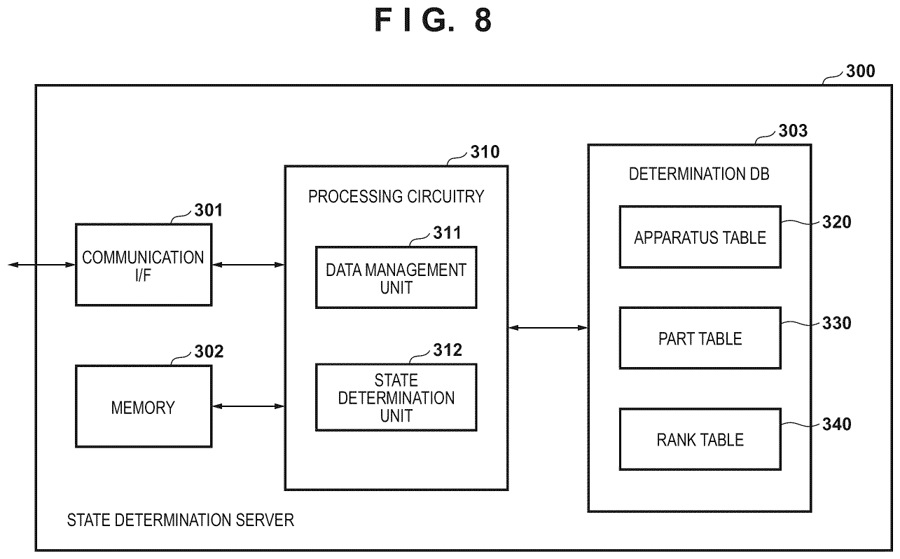

FIG. 7 is an explanatory diagram illustrating an example of a configuration of a rank information record 140 stored in each rank table 230_n. The rank information record 140 includes, in addition to an apparatus identifier including a main body model number 141 and a main body serial number 142, main body state information, unit state information for each of the plurality of units, and determination date 147. Unit here represents a set of one or a plurality of parts 90, and the state information will be provide per unit basis. For example, an image-forming unit may be defined as a set including the fixing device 19 and the intermediate transfer belt 80. Also, a feeding unit may be defined as being constituted by the feeding roller 17 alone. The determination date 147 indicates the date on which the rank for each rank information record 140 was determined.

The main body state information includes an overall rank 143 and a main body lifetime 144. The unit state information includes unit performance 145 and unit lifetime 146. The values for these information items are represented by letters of the alphabet (for example, in ascending rank order, “C”, “B”, “A”, “S”, “S+”, and the like) indicating the rank based on a quantitatively-evaluated score. How each rank is determined on the basis of the history information will be described in detail below.

The processing circuitry 210 may be a CPU, for example, and provides the functions of the history server 200 by executing a computer program stored in the memory 202. More specifically, in the present embodiment, the processing circuitry 210 functions as a history management unit 211 and an information provision unit 212.

The history management unit 211 receives, from the worker terminal 100, the history record 130 for the printer 1 which the worker U1 worked on via the communication I/F 201 and stores the received history record 130 in the corresponding history table 220 in association with the apparatus identifier. As described above, the history record 130 includes information such as the part identifier and number of sheets printed for each part 90 constituting the printer 1 at the time when the work was performed. Also, the history management unit 211 requests the state determination server 300 for a state determination based on the history record 130 each time the history record 130 is added to the management DB 203. Then, the history management unit 211 stores the state information received from the state determination server 300 in the corresponding rank table 230. The state information here may be the rank information described using FIG. 7.

In a case where provision of the history information is requested by another apparatus, the information provision unit 212 extracts the latest history record 130 (or one or more records within a designated time period) from a history table 220 corresponding to a designated apparatus identifier and transmits this to the request source apparatus. Also, in a case where provision of the state information is requested by another apparatus, the information provision unit 212 extracts the latest rank information record 140 (or one or more records within a designated time period) from a rank table 230 corresponding to a designated apparatus identifier and transmits this to the request source apparatus.

### 2-3. State Determination Server

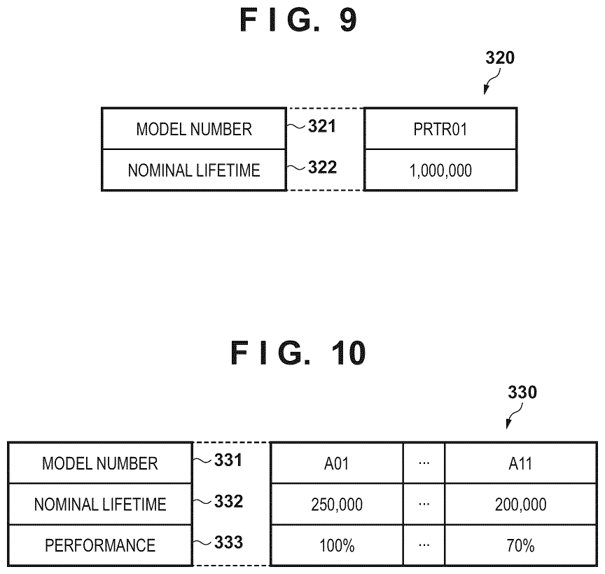

FIG. 8 is a block diagram illustrating an example of a configuration of the state determination server 300. As illustrated in FIG. 8, the state determination server 300 includes a communication I/F 301, a memory 302, a determination DB 303, and processing circuitry 310.

The communication I/F 301 is a communication interface for the state determination server 300 to communicate with other apparatuses. The communication I/F 301 may be a wired communication interface or may be a wireless communication interface.

The memory 302 may include any kind of storage medium such as a semiconductor memory, e.g., a ROM, a RAM, or the like, an optical disk, or a magnetic disk. The memory 302 may include a non-transitory computer-readable storage medium. The memory 302 stores one or more computer programs executed by the processing circuitry 310 and various types of data.

The determination DB 303 is a database that pre-stores data referenced when the state information of the printer 1 is generated based on the history information. In the example of FIG. 8, the determination DB 303 includes an apparatus table 320, a part table 330, and a rank table 340.

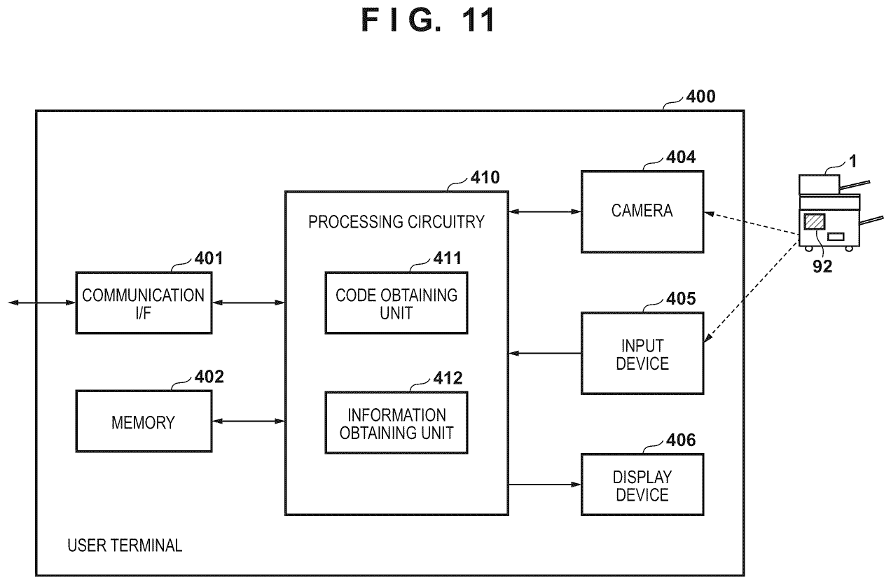

The apparatus table 320 is a table for storing the known lifetime of the apparatus main body for various models of the printers 1 under the management of the system. FIG. 9 is an explanatory diagram illustrating an example of a configuration of the apparatus table 320. The apparatus table 320 includes a model number 321 and a nominal lifetime 322. The model number 321 indicates one of the model numbers of various models of the printer 1. The nominal lifetime 322 indicates the known lifetime of the model of the printer 1 identified by the model number 321. Here, the nominal lifetime is expressed in terms of the number of sheets printable.

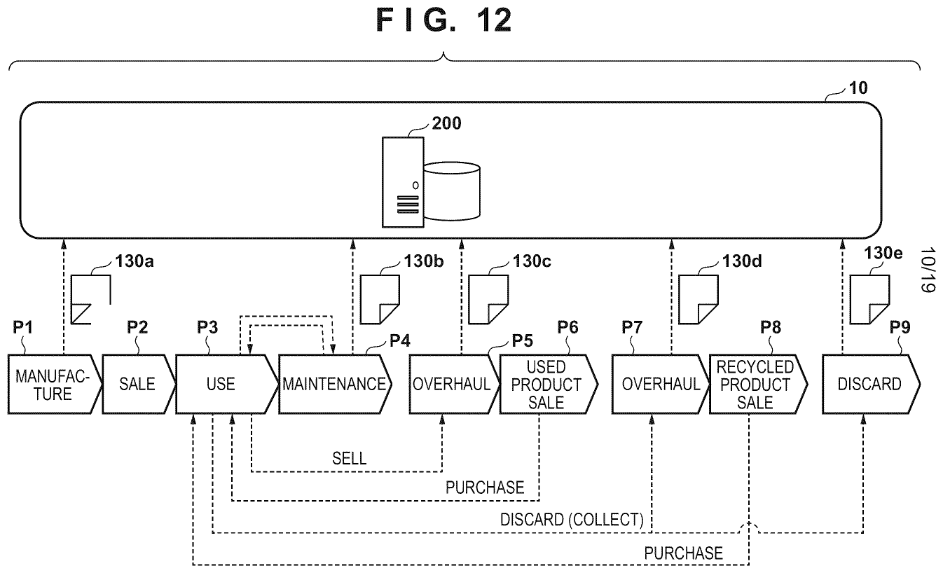

The part table 330 is a table for storing a known lifetime and an index value for known performance of various models of the parts 90 that can be attached to and detached from the printer 1. FIG. 10 is an explanatory diagram illustrating an example of a configuration of the part table 330. The part table 330 includes a model number 331, a nominal lifetime 332, and performance 333. The model number 331 indicates one of the model numbers of the various models of the parts 90. The nominal lifetime 332 indicates a known lifetime of the model identified by the model number 331. Here also, the nominal lifetime is expressed in terms of the number of sheets printable. The performance 333 indicates an index value of the known performance of the model identified by the model number 331 by a percentage to the performance of a reference genuine product.

The rank table 340 is a table defining a rank for each of ranges of numerical measures (hereinafter also referred to as score) calculated for each information item of the rank information record 140 described above. The rank table 340 also defines a message to be presented to the user per determined rank.

The processing circuitry 310 may be a CPU, for example, and provides the functions of the state determination server 300 by executing a computer program stored in the memory 302. More specifically, in the present embodiment, the processing circuitry 310 functions as a data management unit 311 and a state determination unit 312.

The data management unit 311 manages registration, update, and deletion of data in the apparatus table 320 and the part table 330 of the determination DB 303. For example, the data management unit 311 may provide a user interface for the registration, update, and deletion of data to the manufacturer of the printer 1. For example, when a new model printer is manufactured, a coordinator of the manufacturer registers the nominal lifetime of the apparatus main body of this model in the apparatus table 320 and the nominal lifetime and performance of the parts that can be attached to and detached from the apparatus of this model in the part table 330. Not only information of genuine product parts but also information of parts that are recycled products and non-genuine products may also be registered in the part table 330.

The state determination unit 312 determines one or more parts (also referred to as constituting parts) 90 current constituting the designated printer 1 from the latest history record 130 of the printer 1 in response to a state determination request received from the history server 200. The latest history record 130 may be included in the state determination request. Alternatively, the state determination unit 312 may obtain the latest history record 130 from the management DB 203 of the history server 200 on the basis of the apparatus identifier included in the state determination request. The state determination unit 312 generates the state information of the printer 1 on the basis of the state of the determined constituting parts of the printer 1. The state determination unit 312 may generate the state information also on the basis of the state of the main body of the printer 1 in addition to the state of the constituting parts of the printer 1.

The state information generated by the state determination unit 312 may include at least one of the following scores, for example.
“Part Lifetime” remaining lifetime score per part
“Part Performance” performance score per part
“Unit Lifetime” remaining lifetime score per unit
“Unit Performance” performance score per unit
“Main Body Lifetime” remaining lifetime score of main body
   The remaining lifetime score may indicate, as described above, a percentage with respect to the number of sheets printable remaining until the lifetime is exhausted or a reference value. The reference value here may be the nominal lifetime of the same model or the nominal lifetime of a genuine product of the same type. The performance score may indicate a percentage with respect to the performance of a genuine product installed in the printer 1 as a new product. The qualitative meaning of performance may differ for different types of parts. In a case where a unit is only constituted by one part, “Unit Lifetime” is the same as “Part Lifetime”, and “Unit Performance” is the same as “Part Performance”. In a case where a unit is constituted by a plurality of parts, “Unit Lifetime” may be a representative value (for example, average value, median value, maximum value, minimum value, or the like) of “Part Lifetime” of the constituting parts, and “Unit Performance” may be a representative value of “Part Performance” of the constituting parts. An example of a method for calculating the remaining lifetime score and the performance score will be described below.

As described above using FIG. 5, the history record 130 includes an apparatus identifier for identifying an individual instance of the printer 1 and a part identifier for identifying each of one or more constituting parts 90 of that individual instance. The history record 130 further includes a first parameter representing the consumption state of each of the constituting parts 90. The first parameter corresponds to the part number of sheets printed 136, for example, and represents the consumption state in terms of the number of sheets printed using the corresponding part 90. The part table 330 of the determination DB 303 pre-stores a known lifetime, that is, nominal lifetime, of each part 90. For each constituting part 90, the state determination unit 312 calculates the remaining lifetime score of the constituting part 90 on the basis of the nominal lifetime indicated by the part table 330 and the consumption state indicated by the first parameter. For example, a remaining lifetime score LS_{X} of part X may be calculated as a percentage according to the following Expression (1), where the part number of sheets printed of the part X is P_{X} and the nominal lifetime is L_{X}.

$${LS}_{X} ( \% ) = 100 ( 1 - {P}_{X} / {L}_{X} ) \qquad ( 1 )$$

For example, in a case where the part number of sheets printed P₁ of the fixing device is 50000 and the nominal lifetime L₁ is 250000, the remaining lifetime score LS₁ is 80. Also, in a case where the part number of sheets printed P₂ of the intermediate transfer belt is 0 and the nominal lifetime L₂ is 450000, the remaining lifetime score LS₂ is 100. Also, in a case where the part number of sheets printed P₃ of the feeding roller is 25000 and the nominal lifetime L₃ is 40000, the remaining lifetime score LS₃ is 37.5.

In a case where one unit includes N number of the constituting parts 90, the remaining lifetime score LS_{U} of the unit may be calculated according to the following Expression (2).

$${LS}_{U} ( \% ) = ( {LS}_{1} + … + {LS}_{N} ) / N \qquad ( 2 )$$

According to Expression (2), the remaining lifetime score LS_{U} of the unit is equal to the average value of the remaining lifetime scores of the N number of constituting parts 90 of the unit. For example, in a case where the remaining lifetime score LS₁ of the fixing device is 80 and the remaining lifetime score LS₂ of the intermediate transfer belt is 100, the remaining lifetime score LS_{U} of the image-forming unit including the fixing device and the intermediate transfer belt is (80+100)/2=90.

The history record 130 may further include a second parameter representing the consumption state of the main body of the printer 1. The second parameter corresponds to the main body number of sheets printed 133 in the example of FIG. 5, for example, and represents the consumption state in terms of the number of sheets printed using the printer 1. The apparatus table 320 of the determination DB 303 pre-stores the nominal lifetime of the printer 1. The state determination unit 312 calculates the remaining lifetime score of the main body of the printer 1 on the basis of the nominal lifetime indicated by the apparatus table 320 and the consumption state indicated by the second parameter. For example, a remaining lifetime score LS_{M} of the main body of the printer 1 may be calculated according to the following Expression (3), where the main body number of sheets printed of the printer 1 is P_{M} and the nominal lifetime is L_{M}.

$${LS}_{M} ( \% ) = 100 ( 1 - {P}_{M} / {L}_{M} ) \qquad ( 3 )$$

For example, in a case where the main body number of sheets printed P_{M} is 550000 and the nominal lifetime L_{M} is 1000000, the remaining lifetime score LS_{M} is 45.

The part table 330 of the determination DB 303 further pre-stores an index value of known performance of each part 90. For each constituting part 90, the state determination unit 312 calculates a performance score of the constituting part 90 on the basis of the index value of the performance indicated by the part table 330. For example, the performance score of part X may be equal to an index value F_{X} indicated by the part table 330. In a case where one unit includes N number of the constituting parts 90, the performance score PS_{U} of the unit may be calculated according to the following Expression (4).

$${PS}_{U} ( \% ) = ( {F}_{1} + … + {F}_{N} ) / N \qquad ( 4 )$$

According to Expression (4), the performance score PS_{U} of the unit is equal to the average value of the performance scores of the N number of constituting parts 90 of the unit. For example, in a case where the performance score F₁ of the fixing device is 100 and the performance score F₂ of the intermediate transfer belt is 80, the performance score PS_{U} of the image-forming unit including the fixing device and the intermediate transfer belt is (100+80)/2=90.

Note that the method for calculating the score by the state determination unit 312 is not limited to the examples described above. For example, in order to take age deterioration into consideration, the performance score of each constituting part X may be calculated by multiplying, by a coefficient that decreases as the remaining lifetime decreases, the index value of the performance indicated by the part table 330.

The state determination unit 312 may convert each score calculated as described above into a rank by further referencing the rank table 340. In addition, the state determination unit 312 may determine an overall rank for the printer 1 on the basis of ranks of the respective units. For example, the lowest rank from among the ranks of the units may be used as the overall rank of the printer 1.

The rank table 340, for example, may define the correspondence relationship between performance scores and ranks and messages to be presented to a user as indicated in the following Table 1.

TABLE 1
An example of the corresponding relationship between
performance scores and ranks in the rank table

| Performance | | |
|---|---|---|
| Score | | |
| (%) | Rank | Message |
| 101- | S+ | Very high performance |
| 95-100 | S | High performance |
| 90-94 | A | Sufficient performance |
| 70-89 | B | Performance issue may be caused |
| -69 | C | Defect may be frequently caused |

In the example of Table 1, the corresponding relationship between the performance scores and the ranks is commonly defined for the plurality of parts and the plurality of units. For example, the rank of performance of a part or unit with a performance score of 105(%) is “S+”, and the rank of performance of a part or unit with a performance score of 90(%) is “A”. However, the corresponding relationship between the performance scores and the ranks may be defined differently for each type of part or unit.

The rank table 340, for example, may define the corresponding relationship between the remaining lifetime scores and the ranks and messages to be presented to a user as indicated in the following Table 2.

TABLE 2
An example of the corresponding relationship between
remaining lifetime scores and ranks in the rank table

| Remaining | | |
|---|---|---|
| Lifetime Score | | |
| (%) | Rank | Message |
| 90-100 | S | Almost unused |
| 50-89 | A | Sufficient remaining lifetime |
| 20-49 | B | Remaining lifetime getting short |
| -19 | C | Little remaining lifetime |

In the example of Table 2, the remaining lifetime score is represented as a percentage. For example, the rank of lifetime of a part, unit, or main body with a remaining lifetime score of 90% is “S”, and the rank of lifetime of a part, unit, or main body with a remaining lifetime score of 45(%) is “B”.

The rank table 340, for example, may define messages corresponding to overall ranks as indicated in the following Table 3.

TABLE 3
An example of message definitions corresponding
to overall ranks in the rank table

| Overall | |
|---|---|
| Rank | Message |
| S | High performance and almost unused |
| A | Both performance and remaining lifetime sufficient |
| B | Possible performance issue or remaining lifetime |
| | getting short |
| C | Defect may be frequently caused or little remaining |
| | lifetime |
| — | This product has been discarded |

With the example of Table 3, it is assumed that the lowest rank from among the ranks of a plurality of units is used as the overall rank. For the printer 1 which has been discarded, the overall rank is blank, and only a message indicating “discarded” is assigned.

The rank information record 140 illustrated in FIG. 7 is an example of the state information generated by the state determination unit 312. For example, in a case where the unit A is an image-forming unit, the performance of the image-forming unit of the printer 1 at the point in time when the state information is generated is represented by the rank “A” and evaluated as having sufficient performance. The remaining lifetime of the image-forming unit is also represented by the rank “A” and evaluated as having sufficient remaining lifetime. In a case where the unit X is a feeding unit, the performance of the feeding unit of the printer 1 at the point in time when the state information is generated is represented by the rank “S+” and evaluated as having very high performance. The remaining lifetime of the feeding unit is represented by the rank “B” and evaluated as the remaining lifetime getting short. The remaining lifetime of the main body of the printer 1 is also represented by the rank “B” and evaluated as the remaining lifetime getting short. The overall rank of the printer 1 is represented by the rank “B” which is the lowest rank from among the ranks determined for the main body and the plurality of constituting parts.

The state determination unit 312 transmits the rank information record 140 for the printer 1 generated in this manner to the history server 200 as a response to the state determination request from the history server 200. Note that the rank information record 140 may include a message corresponding to each rank as indicated in Tables 1 to 3 in addition to the ranks as illustrated in FIG. 7.

It should be noted that a rank, which is an example of state information, may naturally be expressed using an expression method other than using letters of the alphabet. Ranks of less granularity or more granularity than those indicated in Table 1 and Table 2 may be used. The state information may include one or both of the remaining lifetime score and the performance score described above in addition to or instead of the rank information. Furthermore, information relating to the environmental conditions in which the printer 1 is installed (for example, the temperature or humidity) may be included in the history record 130, and the information relating to the environmental conditions may be taken into account when calculating the scores or determining the ranks.

### 2-4. User Terminal

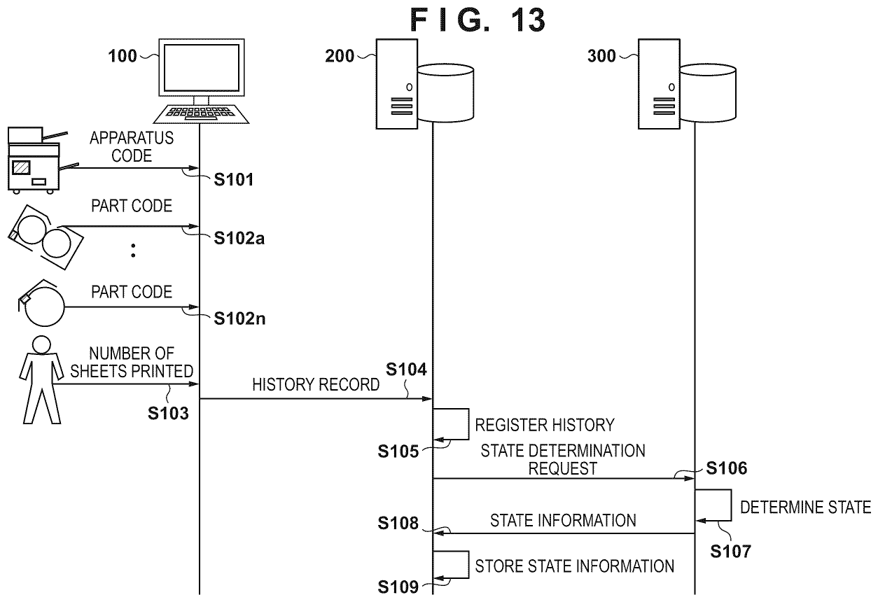

FIG. 11 is a block diagram illustrating an example of a configuration of the user terminal 400 according to an embodiment. As illustrated in FIG. 11, the user terminal 400 includes a communication I/F 401, a memory 402, a camera 404, an input device 405, a display device 406, and processing circuitry 410.

The communication I/F 401 is an interface for the user terminal 400 to communicate with other apparatuses. The communication I/F 401 may be a wired communication interface or may be a wireless communication interface.

The memory 402 may include any kind of storage medium such as a semiconductor memory, e.g. a ROM, a RAM, or the like, an optical disk, or a magnetic disk. The memory 402 may include a non-transitory computer-readable storage medium. The memory 402 stores one or more computer programs executed by the processing circuitry 410 and various types of data.

The camera 404 is a module that is capable of capturing images or video of a subject. In the present embodiment, the camera 404 may be used for optically reading, from the apparatus codes 92 of the printer 1, information encoded in the code.

The input device 405 is a device for accepting operations and information input by the user U2. The input device 405, for example, may include one or more of a touch sensor, a key pad, a keyboard, a pointing device, and a microphone. For example, the apparatus codes 92 may be expressed as characters that can be read by humans. In this case, the code or information visually read by the user U2 may be input to the user terminal 400 via the input device 405.

The display device 406 is a display for outputting images or information. The display device 406, together with the input device 405, provides a user interface related to an action such as making an inquiry for and viewing information by the user U2.

The processing circuitry 410 may be a CPU, for example, and provides the functions of the user terminal 400 by executing a computer program stored in the memory 402. More specifically, in the present embodiment, the processing circuitry 410 functions as a code obtaining unit 411 and an information obtaining unit 412.

The code obtaining unit 411 obtains code information to be read from the apparatus codes 92 of the printer 1 existing in the user environment E2 in cooperation with the camera 404 and the input device 405. An example of the configuration of the code information is as described using FIG. 4.

The information obtaining unit 412 uses the address for access to the history server 200 included in the code information obtained by the code obtaining unit 411 to transmit a request for the state information representing the latest state of the printer 1 to the history server 200 via the network N1. The request transmitted to the history server 200 includes the apparatus identifier for identifying the target printer 1. The information provision unit 212 of the history server 200 transmits the rank information record 140 representing the latest state of the designated printer 1 to the user terminal 400 in response to the request from the user terminal 400. The information obtaining unit 412 displays the state information of the printer 1 obtained from the history server 200 in this manner on the screen of the display device 406. For example, the displayed state information may include ranks of performance and lifetime of each unit of the printer 1, a rank of lifetime of the main body, and an overall rank as described using FIG. 7. The information obtaining unit 412 may obtain the history information indicating the history of part replacement of the printer 1 from the history server 200 and may display the obtained history information on the screen of the display device 406.

### 3. PROCESSING FLOW

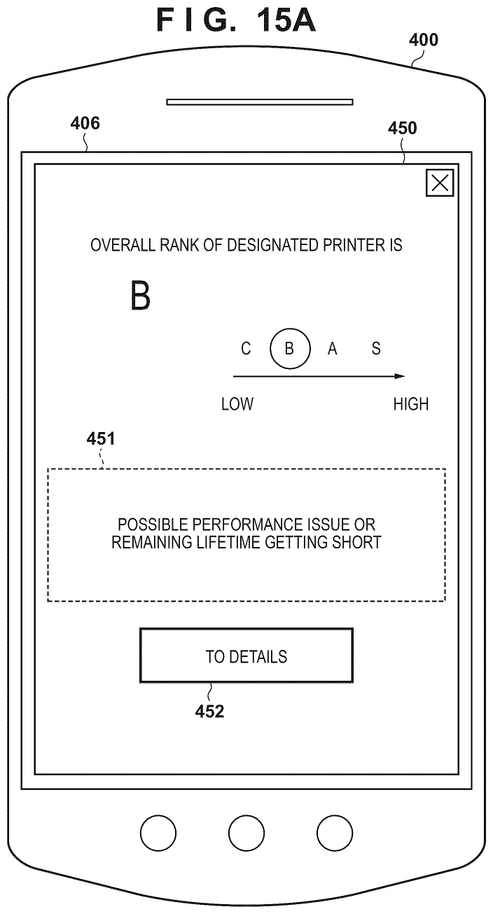

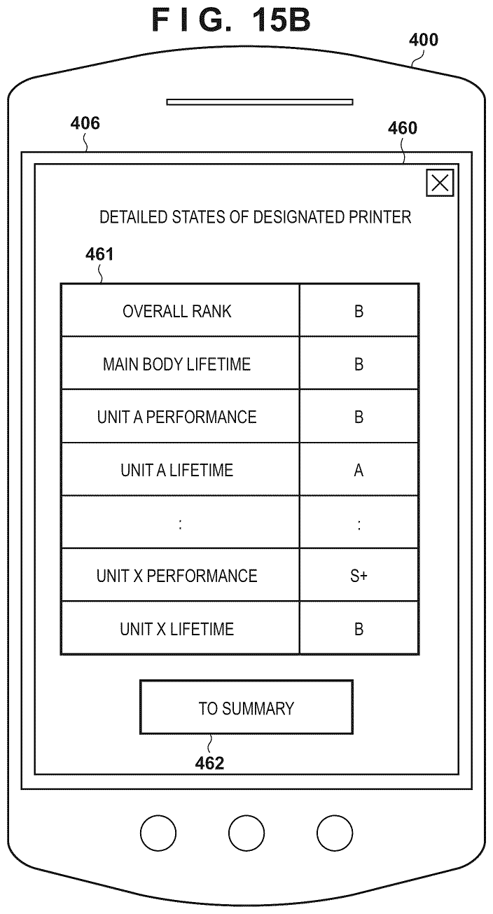

In the present section, examples of flows of the processing executed in the information provision system 10 will be described using the sequence diagrams of FIGS. 13 and 14. The “S” in the sequence diagrams is an abbreviation for processing step.

### 3-1. State Information Generation Processing

FIG. 13 is a sequence diagram illustrating an example of a flow of the state information generation processing according to the present embodiment. The worker terminal 100, the history server 200, and the state determination server 300 are involved in the state information generation processing of FIG. 13. The state information generation processing may be executed at the timings of processes P1 (manufacture), P4 (maintenance), P5 (overhaul), P7 (overhaul), and P9 (discard) of FIG. 12, for example.

First, in S101, the code obtaining unit 111 of the worker terminal 100 obtains the code information obtained from the apparatus codes 92 of the printer 1 existing in the work environment E1. The apparatus codes 92 are optically read by the camera 104 of the worker terminal 100 or visually read by the worker U1, for example. In the case of the latter, the code obtaining unit 111 obtains the code information input by the worker U1 via the input device 105.

Next, in S102a to S102n, the code obtaining unit 111 obtains the code information read from the part codes 91 of the one or more replaceable parts 90 installed in the printer 1. The part codes 91 are also optically read by the camera 104 of the worker terminal 100 or visually read by the worker U1, for example.

Next, in S103, the worker U1 operates the printer 1, references the values for the main body number of sheets printed and the part number of sheets printed for each part, and inputs the values for the number of sheets printed into the worker terminal 100. Note that the values for the main body number of sheets printed and the part number of sheets printed of each part may be transmitted to the worker terminal 100 via a connection between the printer 1 and the worker terminal 100 or may be directly transmitted from the printer 1 to the history server 200. In S104, the history generation unit 112 of the worker terminal 100 generates the history record 130 from the code information of the apparatus main body and the one or more parts of the printer 1 obtained by the code obtaining unit 111 and transmits the generated history record 130 to the history server 200.

Next, in S105, the history management unit 211 of the history server 200 registers the history information included in the history record 130 received from the worker terminal 100 in the history table 220 of the management DB 203 in association with the apparatus identifier indicated by the history record 130.

Next, in S106, the history management unit 211 transmits a state determination request including the received history record 130 to the state determination server 300. In S107, in response to receiving the state determination request, the state determination unit 312 of the state determination server 300 determines one or more constituting parts 90 constituting the designated printer 1 from the history record 130. Also, the state determination unit 312 generates the state information described above on the basis of the state of the determined constituting parts of the printer 1.

Next, in S108, the state determination unit 312 transmits the state information (for example, information indicating the score or rank described above) of the printer 1 to the history server 200 as a response to the state determination request. In S109, the history management unit 211 of the history server 200 stores the state information received from the state determination unit 312 in the management DB 203.

### 3-2. Information Provision Processing

FIG. 14 is a sequence diagram illustrating an example of a flow of the information provision processing according to the present embodiment. The history server 200 and the user terminal 400 are involved in the information provision processing of FIG. 14. The information provision processing, for example, may be executed at the timings of processes P2 (sale), P6 (used product sale), and P8 (recycled product sale) of FIG. 12, for example.

First, in S151, the code obtaining unit 411 of the user terminal 400 obtains the code information read from the apparatus codes 92 of the printer 1 existing in the user environment E2. The apparatus codes 92 are optically read by the camera 404 of the user terminal 400 or visually read by the user U2. In the case of the latter, the code obtaining unit 411 obtains the code information input by the user U2 via the input device 405.

Next, in S152, the information obtaining unit 412 of the user terminal 400 uses the address included in the code information obtained by the code obtaining unit 411 to transmit an information provision request for provision of the state information of the printer 1 to the history server 200. In S153, in response to the information provision request, the information provision unit 212 of the history server 200 obtains the latest history record 130 from the history table 220 corresponding to the designated apparatus identifier and the latest rank information record 140 from the rank table 230.

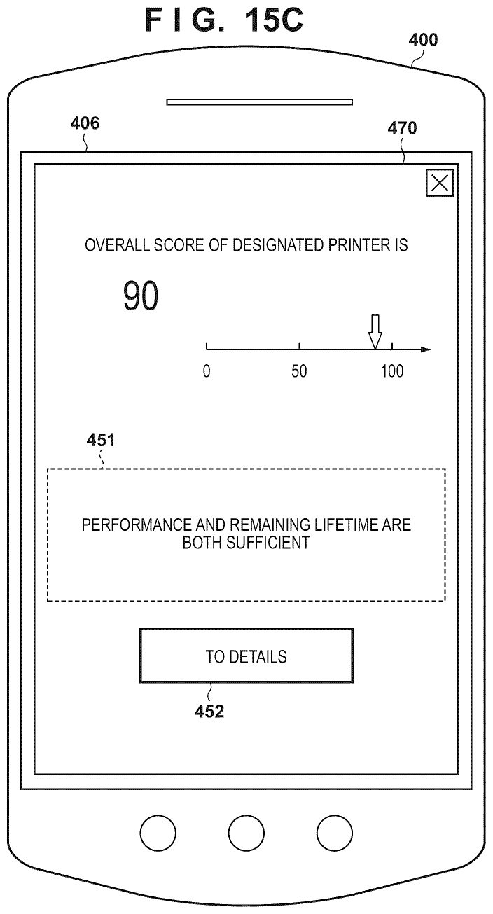

Next, in S154, the information provision unit 212 transmits the obtained history record 130 and the rank information record 140 to the user terminal 400 as a response to the information provision request. In S155, the information obtaining unit 412 displays the state information provided from the history server 200 on the screen of the display device 406. The information displayed here may include, for example, one or more of the scores, ranks, and messages corresponding to the ranks as described above. Some examples of the screen displaying the state information will be described below using FIGS. 15A to 15C. Also, the information obtaining unit 412 may display the history information provided from the history server 200 on the screen of the display device 406. The user interface of the display device 406 may be configured such that it allows a user to designate which information provision to request to the history server 200.

### 4. SCREEN EXAMPLES

FIG. 15A is an explanatory diagram illustrating a first example of a configuration of a screen displaying the state information. As illustrated in FIG. 15A, a summary display screen 450 is displayed on the display device 406 of the user terminal 400. The summary display screen 450 includes a letter of the alphabet (“B” in the illustrated example) indicating the overall rank of the printer designated in the information provision request. The summary display screen 450 further includes a message region 451 and a button 452. In the message region 451, a message corresponding to the overall rank as defined in the rank table 340 is displayed. The button 452 is a button for transitioning to a screen displaying more detailed state information of the designated printer (for example, a detailed display screen 460 described next).

FIG. 15B is an explanatory diagram illustrating a second example of a configuration of a screen displaying the state information. As illustrated in FIG. 15B, the detailed display screen 460 is displayed on the display device 406 of the user terminal 400. The detailed display screen 460 includes a detailed display region 461 and a button 462. The detailed display region 461 is a region displaying letters of the alphabet indicating the overall rank, the main body lifetime, and the rank of performance and lifetime for units A to X in a table format. When the user operates each row of the detailed display screen 460, a message corresponding to the score of the operated row may be further displayed. The button 462 is a button for transitioning to a screen displaying general information for the designated printer (for example, the summary display screen 450 described above).

Note that the configuration of the screen that displays the state information is not limited to the examples described above. For example, a numerical value indicating a score may be displayed in addition to or instead of a letter of the alphabet indicating the rank. FIG. 15C is an explanatory diagram illustrating a third example of a configuration of a screen displaying the state information. As illustrated in FIG. 15C, a summary display screen 470 is displayed on the display device 406 of the user terminal 400. The summary display screen 470 includes a numerical value (“90” in the illustrated example) indicating the overall score of the printer designated in the information provision request and the message region 451 and the button 452. Naturally, the state information for each unit described using FIG. 15B may also be indicated using similar numerical values.

By viewing the state information displayed on the screen in this manner, the user can comprehend the objective evaluation of the state, such as the remaining lifetime and performance, that is based on the current configuration of the printer being sold as a new product or a used product, for example. In particular, using a measure that is easy to intuitively understand such as the ranks or scores described above is beneficial to a user that does not have deep knowledge about printers. The user can appropriately make a judgement on whether or not to actually purchase a printer they are interested in by taking into account the index values provided on the screen together with other information such as a price.

### 5. MODIFICATION EXAMPLES

The technology according to the present disclosure is not limited to a configuration of the information provision system 10 described above. In the present section, two further modification examples of the information provision system 10 will be described.

### 5-1. First Modification Example

In the embodiment described above, the state information generated by the state determination server 300 is accumulated in the management DB 203 of the history server 200, and the state information is provided to the user terminal 400 by the information provision unit 212 of the history server 200 in response to a request from the user terminal 400. However, in the present modification example, the database of the history server does accumulate the history information but does not accumulate the state information. The state information (for example, rank information) may be generated on-demand by a state determination server in response to a request from the user terminal 400. Accordingly, memory resources are not required for state information in the database of the history server and the communication and computation load of the history server in conjunction with exchanging the state information is reduced.

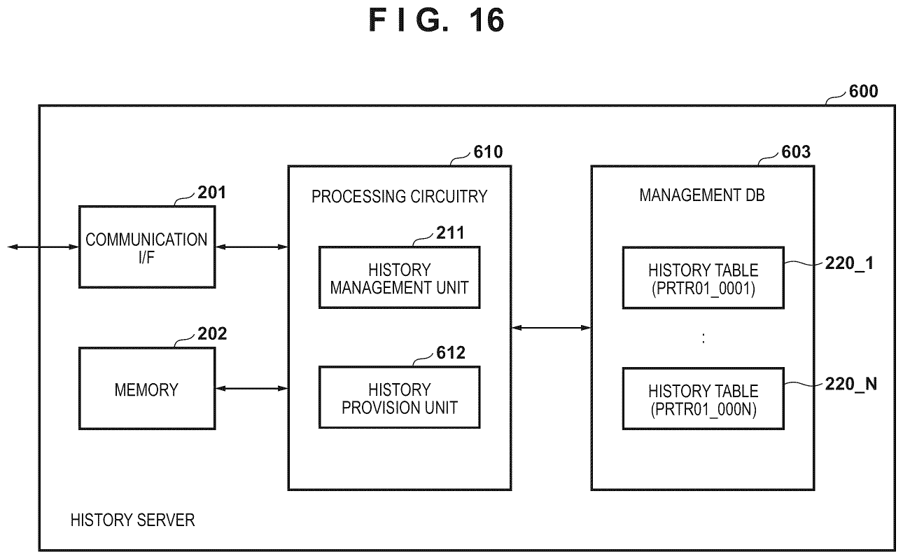

FIG. 16 is a block diagram illustrating an example of a configuration of a history server 600 according to the present modification example. As illustrated in FIG. 16, the history server 600 includes the communication I/F 201, the memory 202, a management DB 603, and processing circuitry 610.

The management DB 603 is a database storing the history information indicating the replacement history for the parts 90 constituting each printer 1 under the management of the system. The history information is stored in association with the apparatus identifier of each printer 1 on the basis of the history record 130 received from the work environment E1.

In the example of FIG. 16, for each of the N number of printers 1 (N being a natural number), the management DB 203 includes the history table 220_n (n=1, . . . , N). However, in the present modification example, the management DB 203 does not include the rank table 230_n.

The processing circuitry 610 may be a CPU, for example, and provides the functions of the history server 600 by executing a computer program stored in the memory 202. More specifically, in the present embodiment, the processing circuitry 610 functions as the history management unit 211 and a history provision unit 612.

In a case where provision of the history information is requested by another apparatus, the history provision unit 612 extracts the latest history record 130 (or one or more records within a designated time period) from the history table 220 corresponding to the designated apparatus identifier and transmits this to the apparatus.

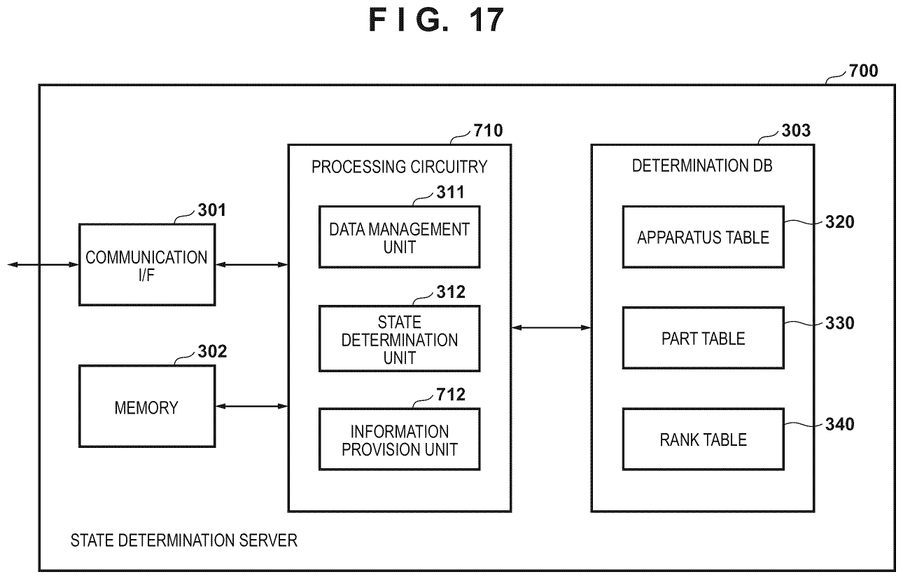

FIG. 17 is a block diagram illustrating an example of a configuration of a state determination server 700. As illustrated in FIG. 17, the state determination server 700 includes the communication I/F 301, the memory 302, the determination DB 303, and processing circuitry 710.

The processing circuitry 710 may be a CPU, for example, and provides the functions of the state determination server 700 by executing a computer program stored in the memory 302. More specifically, in the present embodiment, the processing circuitry 710 functions as the data management unit 311, the state determination unit 312, and an information provision unit 712.

In a case where provision of state information is requested by the user terminal 400, the information provision unit 712 causes the state determination unit 312 to generate state information indicating the current state of the designated printer 1. For example, the state determination unit 312 generates state information as in the embodiment described above on the basis of the history record 130 included in the state information request received from the user terminal 400. Alternatively, the state determination unit 312 may obtain the latest history record 130 associated with the apparatus identifier designated by the user terminal 400 from the management DB 603 of the history server 600 and generate state information on the basis of the obtained history record 130. The information provision unit 712 transmits the state information generated by the state determination unit 312 to the requesting user terminal 400.

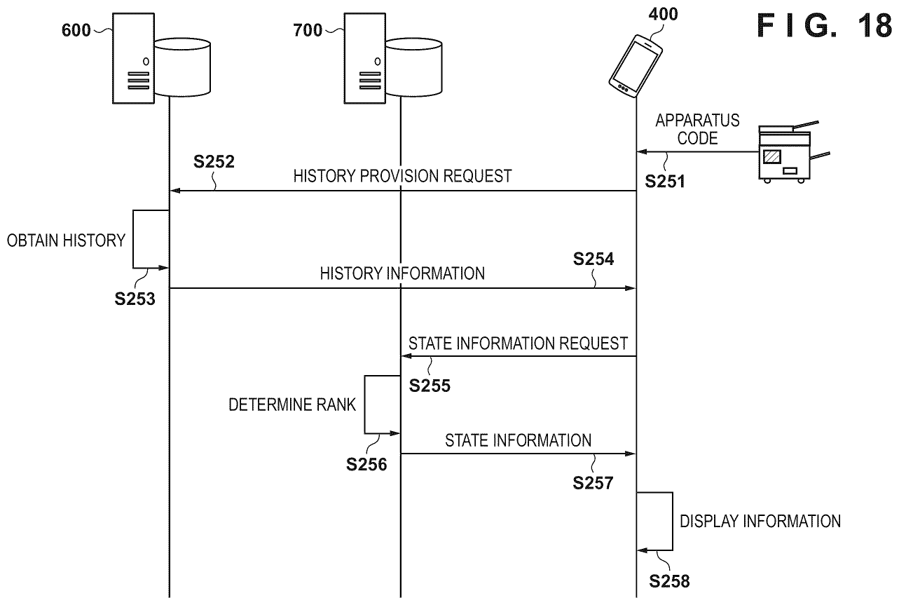

FIG. 18 is a sequence diagram illustrating an example of a flow of the information provision processing according to the present modification example. The history server 600, the state determination server 700, and the user terminal 400 are involved in the information provision processing of FIG. 18. The information provision processing, for example, may be executed at the timings of processes P2 (sale), P6 (used product sale), and P8 (recycled product sale) of FIG. 12, for example.

First, in S251, the code obtaining unit 411 of the user terminal 400 obtains the code information read from the apparatus codes 92 of the printer 1 existing in the user environment E2. The apparatus codes 92 are optically read by the camera 404 of the user terminal 400 or visually read by the user U2. In the case of the latter, the code obtaining unit 411 obtains the code information input by the user U2 via the input device 405.

Next, in S252, the information obtaining unit 412 of the user terminal 400 uses the address included in the code information obtained by the code obtaining unit 411 to transmit a history provision request for provision of history information relating to the current configuration of the printer 1 to the history server 600. In S253, in response to the history provision request, the history provision unit 612 of the history server 600 obtains the latest history record 130 from the history table 220 corresponding to the designated apparatus identifier. Next, in S254, the history provision unit 612 transmits the obtained history record 130 to the user terminal 400 as a response to the history provision request.

Next, in S255, the information obtaining unit 412 of the user terminal 400 transmits a state information request for provision of the state information of the printer 1 to the state determination server 700. The code information read from the apparatus codes 92 of the printer 1 in S251 may additionally include the address of the state determination server 700. Alternatively, in S254, the history provision unit 612 of the history server 600 may notify the user terminal 400 of the address of the state determination server 700. The state information request includes the history record 130 received from the history server 600 in S254.

In S256, in response to receiving the state information request, the information provision unit 712 of the state determination server 700 passes the history record 130 included in the received state information request to the state determination unit 312. The state determination unit 312 determines the one or more constituting parts 90 constituting the target printer 1 from the history record 130. Also, the state determination unit 312 generates the state information described above on the basis of the state of the determined constituting parts of the printer 1.

Next, in S257, the information provision unit 712 transmits the state information generated by the state determination unit 312 to the user terminal 400 as a response to the state information request. In S258, the information obtaining unit 412 of the user terminal 400 displays the state information provided from the state determination server 700 on the screen of the display device 406 (see FIGS. 15A to 15C). By viewing the displayed state information, the user can comprehend the objective evaluation of the state, such as the remaining lifetime and performance, that is based on the current configuration of the printer 1 being sold and appropriately make a judgement on how to treat the printer 1.

### 5-2. Second Modification Example

In the second modification example, the function of code obtaining and history generating of the worker terminal 100 described above are integrated into the printer 1. Accordingly, the information provision system 10 can collect the history information indicating the parts replacement history of the printer 1 in the database, without the need for the worker U1 who performs the work of maintenance and overhauling the printer 1 to use the worker terminal 100 separately prepared.

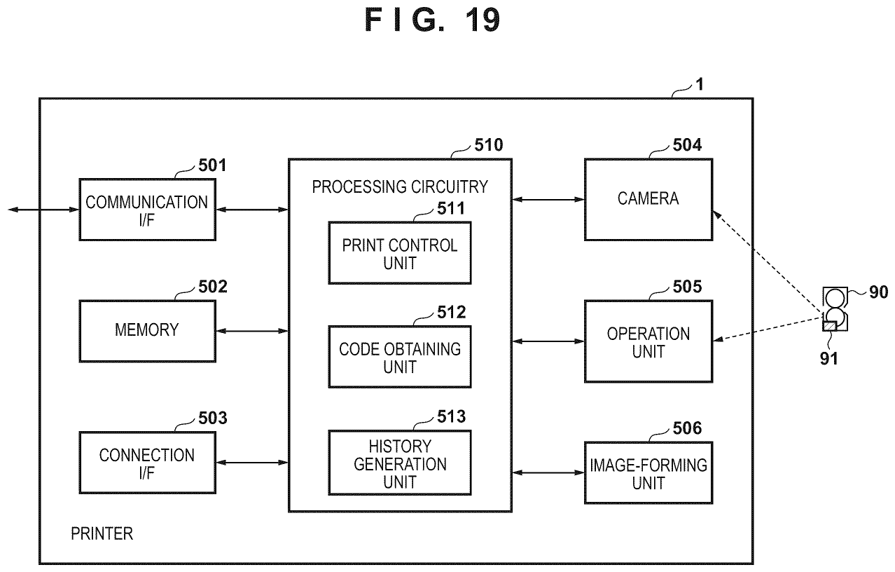

FIG. 19 is a block diagram illustrating an example of a configuration of the printer 1 according to the present modification example. As illustrated in FIG. 19, the printer 1 includes a communication I/F 501, a memory 502, a connection I/F 503, a camera 504, an operation unit 505, an image-forming unit 506, and processing circuitry 510.

The communication I/F 501 is an interface for the printer 1 to communicate with other apparatuses. The communication I/F 501 may be a wired communication interface or may be a wireless communication interface.

The memory 502 may include any kind of storage medium such a semiconductor memory, e.g. a ROM, a RAM, or the like, an optical disk, or a magnetic disk. The memory 502 may include a non-transitory computer-readable storage medium. The memory 502 stores one or more computer programs executed by the processing circuitry 510 and various types of data. For example, the memory 502 pre-stores the code information represented by the apparatus codes 92 of the printer 1. Also, the memory 502 stores sheet number data indicating the cumulative number of sheets printed in the past by the printer 1. The sheet number data may indicate the number of sheets printed per constituting part 90 of the printer 1 separately from the number of sheets printed for the main body of the printer 1.

The connection I/F 503 is an interface for the printer 1 to accept connections from peripheral devices. The connection between the printer 1 and the peripheral devices may be a wired connection or a wireless connection.

The camera 504 is a module that is capable of capturing images or video of a subject. In the present modification embodiment, the camera 504 may be used for optically reading, from each of the part codes 91 of the one or more parts 90 installed in the printer 1, information encoded in the code.

The operation unit 505 includes an input device for accepting operations for the printer 1 and information input and a display device for outputting images or information. For example, the part codes 91 may be expressed as characters that can be read by humans. In this case, the code or information visually read by the worker U1 may be input to the printer 1 via the operation unit 505.

The image-forming unit 506 is a unit that forms images on sheets on the basis of input image data. An example of the physical configuration of the image-forming unit 506 is as described using FIG. 1.

The processing circuitry 510 may be a CPU, for example, and controls the overall operations of the printer 1 by executing a computer program stored in the memory 502. More specifically, in the present modification example, the processing circuitry 510 functions as a print control unit 511, a code obtaining unit 512, and a history generation unit 513.

In a case where there is an instruction to execute an image-formation job via the communication I/F 501 or the operation unit 505, the print control unit 511 controls the image-forming unit 506 to form an image on a sheet according to the job settings. When job execution has ended, the print control unit 511 updates the sheet number data stored in the memory 502.

The code obtaining unit 512 cooperates with the camera 504 and the operation unit 505 to obtain the code information read from the part codes 91 of the one or more constituting parts 90 installed in the printer 1.

The history generation unit 513 generates the history record 130 for the one or more constituting parts 90 of the printer 1 on the basis of the code information stored in the memory 502, the sheet number data, and the code information obtained by the code obtaining unit 512. Then, the history generation unit 513 transmits the generated history record 130 to the history server 200. The transmission of the history record 130 to the history server 200 by the history generation unit 513 is triggered by an instruction from the worker U1 accepted on the screen of the operation unit 505, for example.

The history server 200 stores the history record 130 received from the printer 1 in this manner in the corresponding history table 220 of the management DB 203 in association with the apparatus identifier of the printer 1. Each time the history record 130 is added to the management DB 203, the state determination server 300 determines the state of the printer 1 on the basis of the history record 130 and generates the state information. The user terminal 400 requests the history server 200 or the state determination server 300 for provision of the state information of the printer 1 and displays the state information of the printer 1 provided in response to the request on the screen of the display.

### 6. CONCLUSION

Various embodiments, embodiment examples, and modification examples of the technology according to the present disclosure have been described above using FIGS. 1 to 19. According to the embodiments described above, history information indicating the replacement history of replaceable parts constituting an image-forming apparatus are stored in a database. A generation unit of an information provision system determines one or more parts currently constituting the image-forming apparatus from the history information and generates state information of the image-forming apparatus based on a state of the one or more parts. An information provision unit provides the state information of the image-forming apparatus generated by the generation unit to a user terminal in response to a request from the user terminal. That is, even in a case where one or more genuine product parts originally installed in the image-forming apparatus is replaced with another part, state information appropriately reflecting the latest state of the image-forming apparatus can be provided to the user. The user can view the state information provided in this manner and comprehend the appropriate value of the image-forming apparatus and appropriately decide their intention as to whether to purchase or acquire the apparatus.

Also, in the embodiments described above, the history information includes a first parameter representing a consumption state of each constituting part of the image-forming apparatus, and the state information includes a rank for the remaining lifetime determined on the basis of the first parameter for each constituting part. The rank for each constituting part may be determined on the basis of a known lifetime and the consumption state indicated by the first parameter. Thus, the user can objectively comprehend how long in use the constituting part of the image-forming apparatus can withstand by viewing the state information before deciding their intention.

Also, in the embodiments described above, the history information further includes a second parameter representing a consumption state of the image-forming apparatus, and the state information further includes a rank for the remaining lifetime determined on the basis of the second parameter for the image-forming apparatus. The rank for the image-forming apparatus may be determined on the basis of a known lifetime and the consumption state indicated by the second parameter. Thus, the user can objectively comprehend how long in use the image-forming apparatus can overall withstand by viewing the state information before deciding their intention.

Also, in the embodiments described above, the state information includes a rank for performance determined from a known performance index value for each constituting part. Thus, the user can objectively comprehend how much performance to expect from the constituting parts of the image-forming apparatus by viewing the state information before deciding their intention.

Also, in the embodiments described above, each of the parts that may constitute the image-forming apparatus is provided with an identifier for identifying the part. When the worker performs work to replace at least one part of the image-forming apparatus, the history information is registered in the database in association with the identifier read from each constituting part installed in the image-forming apparatus. Thus, in the information provision system, the history information indicating the state of the constituting parts of the image-forming apparatus after the work can be efficiently collected.

Also, in the embodiments described above, the image-forming apparatus is provided with a code with an encoded address for accessing a server apparatus configured to manage the database. The user terminal uses the address read from the code to transmit the request for the state information to the server apparatus. Accordingly, if the user is interested in the image-forming apparatus, the user can easily get the provided state information of the image-forming apparatus by simply operating the user terminal.

The technology according to the present specification may contribute to realization of a sustainable society such as a decarbonized/recycling-oriented society.

### 7. OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of priorities from Japanese Patent Application No. 2024-139975, filed on Aug. 21, 2024 and Japanese Patent Application No. 2025-045621, filed on Mar. 19, 2025 which are hereby incorporated by references herein in their entirety.

What is claimed is:

1. An information provision system comprising:
a database configured to store history information indicating a replacement history of replaceable parts constituting an image-forming apparatus;
a generation unit configured to determine one or more parts currently constituting the image-forming apparatus from the history information and generate state information of the image-forming apparatus based on a state of the one or more parts; and
an information provision unit configured to provide the state information of the image-forming apparatus generated by the generation unit to a user terminal, in response to a request from the user terminal.

2. The information provision system according to claim 1, wherein
the history information includes a first parameter representing a consumption state of each of the one or more parts, and
the state information of the image-forming apparatus includes a rank for a remaining lifetime determined based on the first parameter for each of the one or more parts.

3. The information provision system according to claim 2, wherein the generation unit is configured to determine the rank for the remaining lifetime based on a known lifetime and the consumption state indicated by the first parameter for each of the one or more parts.

4. The information provision system according to claim 2, wherein the history information includes the first parameter for each part constituting the image-forming apparatus at a time when at least one part of the image-forming apparatus has been replaced.

5. The information provision system according to claim 2, wherein
the history information further includes a second parameter representing a consumption state of the image-forming apparatus, and
the state information of the image-forming apparatus further includes a rank for a remaining lifetime determined based on the second parameter for the image-forming apparatus.

6. The information provision system according to claim 2, wherein the consumption state is expressed in terms of a number of sheets printed.

7. The information provision system according to claim 1, wherein the state information of the image-forming apparatus includes a rank for performance determined from a known performance index value for each of the one or more parts.

8. The information provision system according to claim 1, wherein
each of a plurality of parts that can constitute the image-forming apparatus is provided with an identifier for identifying the part,
the information provision system comprises:
a server apparatus configured to manage the database; and
a worker terminal that is used by a worker who performs a work to replace at least one part of the image-forming apparatus and is configured to transmit the identifier read at a time of performing the work to the server apparatus, and
the server apparatus is configured to store the history information for each part constituting the image-forming apparatus in the database in association with the identifier received from the worker terminal.

9. The information provision system according to claim 1, wherein
the information provision system comprises:
a server apparatus configured to manage the database; and
the image-forming apparatus,
each of a plurality of parts that can constitute the image-forming apparatus is provided with an identifier for identifying the part,
the image-forming apparatus is configured to transmit, to the server apparatus, the identifier read at a time of performing a work to replace at least one part of the image-forming apparatus, and
the server apparatus is configured to store the history information for each part constituting the image-forming apparatus in the database in association with the identifier received from the image-forming apparatus.

10. The information provision system according to claim 1, wherein
the image-forming apparatus is provided with a code with an encoded address for accessing a server apparatus configured to manage the database, and
the user terminal is configured to use the address obtained by reading the code to transmit the request for the state information of the image-forming apparatus to the server apparatus.

11. The information provision system according to claim 1, wherein
the database is configured to further store the state information generated by the generation unit, and
the information provision unit is configured to obtain the state information from the database and provides the state information to the user terminal in response to the request from the user terminal.

12. The information provision system according to claim 1, wherein
the user terminal is configured to obtain the history information from the database to transmit the obtained history information to the information provision unit together with the request, and
the information provision unit is configured to provide, to the user terminal, the state information generated by the generation unit using the history information received from the user terminal.

13. An information provision method performed by a server apparatus that is capable of performing communication with a user terminal, the information provision method comprising:
storing history information indicating a replacement history of replaceable parts constituting an image-forming apparatus in a database;
determining one or more parts currently constituting the image-forming apparatus from the history information stored in the database;
generating state information of the image-forming apparatus based on a state of the one or more parts; and
providing the generated state information of the image-forming apparatus to the user terminal, in response to a request from the user terminal.
